(19) United States
(12) Patent Application Publication
(10) Pub. No.: US 2021/0252818 A1
(43) Pub. Date: Aug. 19, 2021

(54) Turbo Auger

(71) Applicant: Craig Yager, Waverly, MN (US)

(72) Inventor: Craig Yager, Waverly, MN (US)

(21) Appl. No.: 17/175,763

(22) Filed: Feb. 15, 2021

Related U.S. Application Data
(60) Provisional application No. 62/977,581, filed on Feb. 17, 2020.

(51) Int. Cl. B30B 9/30; A01F 25/14

(52) U.S. Cl. CPC B30B 9/301; A01F 2025/145; A01F 25/14

(57) ABSTRACT

A compacting machine of the type having a compaction rotor, the improvement being a rotating auger positioned before the compaction rotor, to spread material to be compacted along an entire front of the compaction rotor.

### CROSS-REFERENCE TO RELATED APPLICATIONS

This application claims priority to provisional patent application 62/977,581, filed Feb. 17, 2020.

### STATEMENT REGARDING FEDERALLY SPONSORED RESEARCH

Not Applicable

### FIELD OF THE INVENTION

The invention relates to an auger which improves the feeding of a forage bagger machine.

### BACKGROUND OF THE INVENTION

A forage bagger is an agriculture piece of farm equipment used to compact silage and grains with a rotating compaction cylinder (rotor) in a horizontally expandable bag. An example of a forage bagger is the G6000 AG-BAG machine. In the commercially available forage bagger machines, the materials to be compacted are conveyed to one or two spots or positions, feeding the rotor. This is undesirable because it not only feeds the compaction rotor unevenly but also materials can bridge up by sticking to the area opposing the rotor where the compaction process begins.

### BRIEF SUMMARY OF THE INVENTION

The invention is a rotating auger positioned in front of the compaction rotor that carries materials to evenly distribute the materials across the full front face of the rotor. This provides the following advantages:

1. Causes more even compaction in the bag eliminating soft spots resulting in better quality feed and more feed per foot of bag.

2. Stops bridging of feed in front of the compaction rotor by spreading the material out along the entire length of the rotor, resulting in faster unloading times so as not to stop silage wagons or slow to allow feed to process through machine. This also is safer as it precludes the need for a worker to feel compelled to physically help push materials into the rotor with a hand tool or a limb, which can be very dangerous and could result in injury or death.

3. The more even distribution of material allows the machine to run smoother by stopping the loping effect of the uneven loading of the machine, which lowers the stress of the mechanical components involved. This results in less broken rotors, rotor bearings, drive chain, gearbox, pto, tractor pto clutches, less horse power needed, and saving fuel.

This new invention will ultimately help producers make better feed, storing more feed for the money, faster, safer, lower maintenance costs and save fuel.

### BRIEF DESCRIPTION OF THE DRAWINGS

FIG. 1 is a view of a conventional forage bagger.

FIG. 2 is a view of the inventive turbo auger, which improves the forage bagger machine.

FIG. 3 is a view of the inventive turbo auger installed in the forage bagger machine.

FIG. 4 is a view showing material being inserted into the forage bagger machine, which is spread along the entire front of the compaction rotor by the rotating turbo auger.

FIG. 5 is a view showing the motor which causes the turbo auger to rotate.

FIG. 6 is a view showing the other end of the auger extending through the wall of the forage bagger machine.

FIG. 7 is a view showing the compaction rotor of a conventional forage bagger machine.

FIG. 8 is a view showing a mini auger used for show display.

FIG. 9 is a view showing the 8 inch spacing between flights (pitch) next to a version with 5 inch spacing between flights.

FIG. 10 is a view showing an alternate embodiment of the turbo auger, with a two way feed arrangement.

FIG. 11 is another view showing the alternative embodiment installed in a forage bagger machine.

FIG. 12 is another view showing the alterative embodiment installed in a forage bagger machine with 8 inch spacing and 8 inch width.

FIG. 13 is a view showing the parts of the inventive turbo auger.

FIG. 14 is an enlarged view showing the 8 inch spacing of the flights of the auger.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

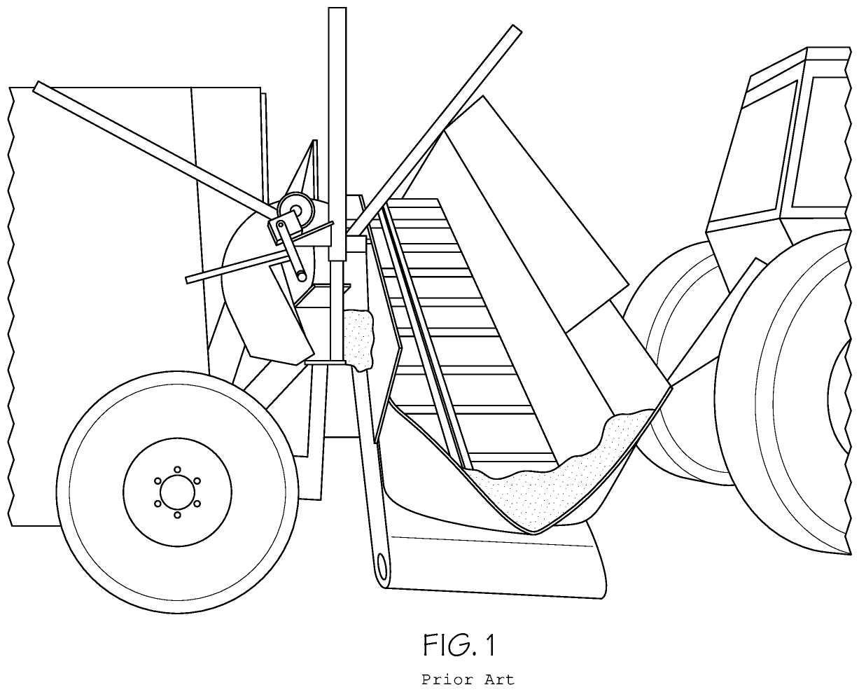

FIG. 1 shows a conventional forage bagger with the feeding mechanism for inserting material into the machine, and the expandable bag the material is compacted into.

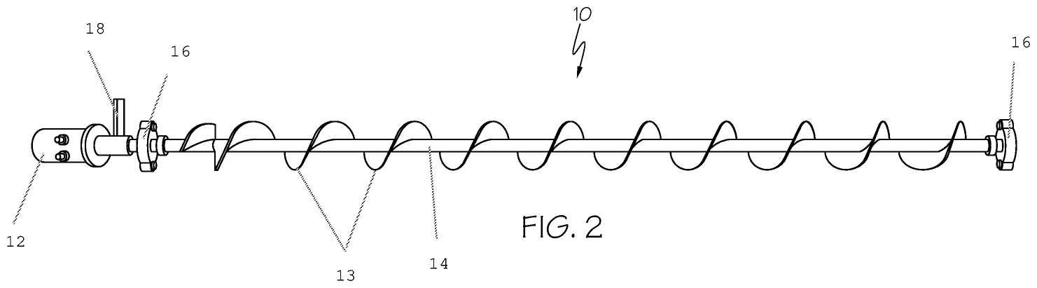

FIG. 2 is a view of the inventive turbo auger, shown generally at 10 and prior to installation in the forage bagger system, which improves the forage bagger machine, as discussed above.

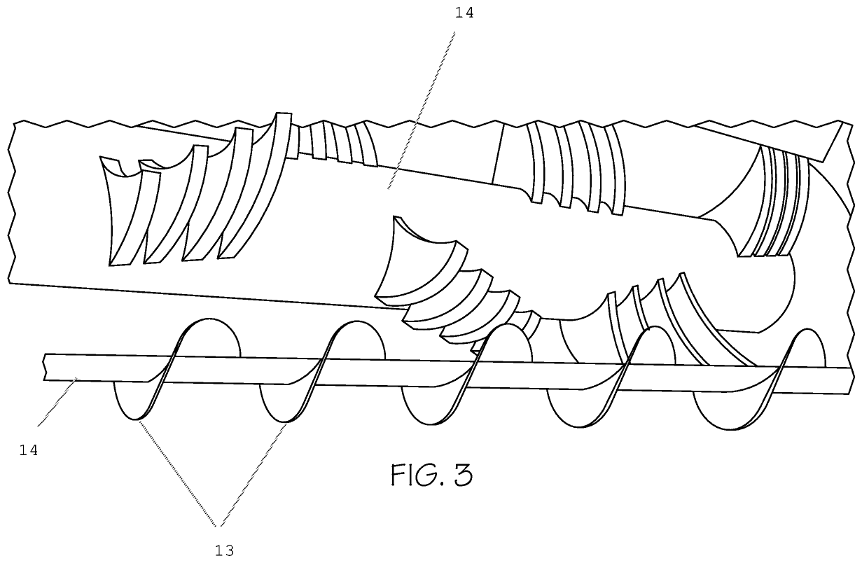

FIG. 3 is a view of the inventive turbo auger installed in the forage bagger machine (hopper not shown). Testing showed that the best position for the auger 10 is one inch above the floor of the machine (i.e. in the hopper) and 1 inch in front of the compaction rotor 11. The auger 10 rod (also called shaft herein) is preferable made of 4140 steel, although it could be made of any desired material, with the flights 13 being spaced 8 inches apart and extending 2.5 inches from the center of the shaft 14, with the shaft being 1.25 inches in diameter.

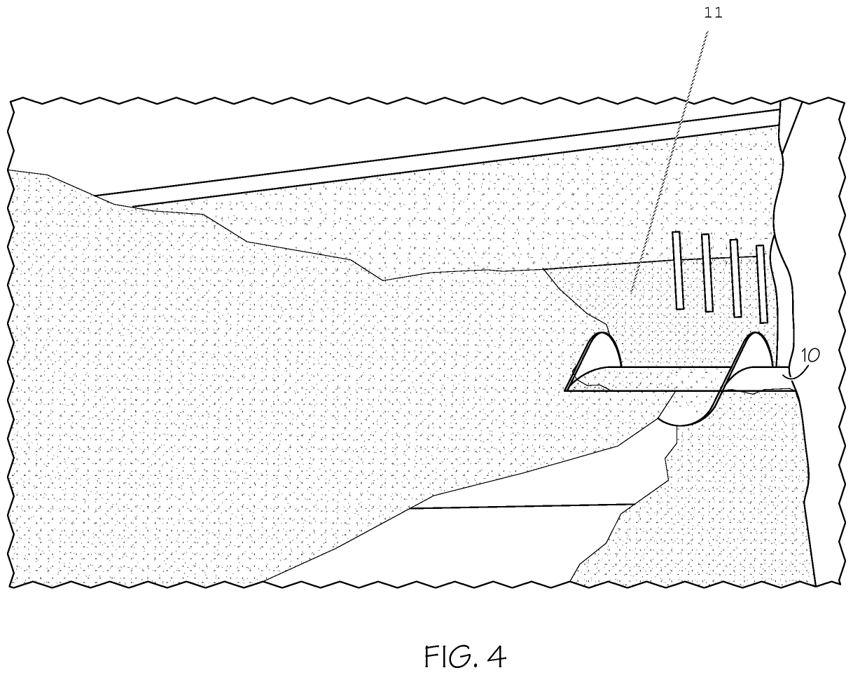

FIG. 4 is a view showing material being inserted into the forage bagger machine, which is spread along the entire front of the compaction rotor 11 by the rotating turbo auger 10.

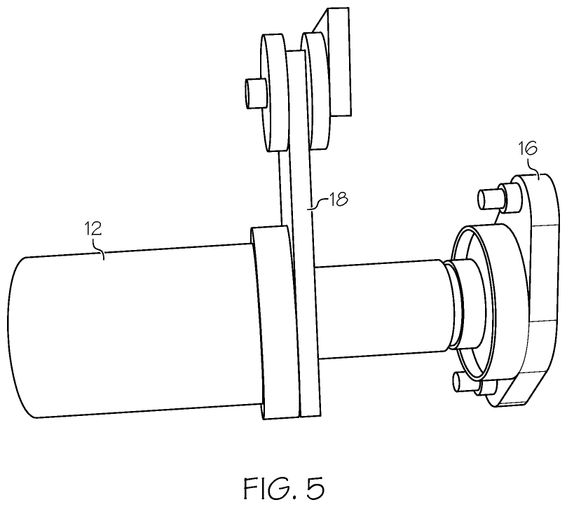

FIG. 5 is a view showing the motor 12 which causes the turbo auger to rotate. Reference numeral 16 shows a bearing which secures the rod of the auger to the forage bagger machine (or any machine using a compaction rotor). Reference numeral 12 is the motor which makes the auger 10 rotate. The auger 10 can be rotated at any desired speed, but 300 rpm is found to provide a good distribution of material being feed to the compaction rotor 11 in testing. Reference numeral 18 is an attachment plate which supports the motor 12 and attaches the turbo auger to the forage bagger machine (or any machine using a compaction rotor).

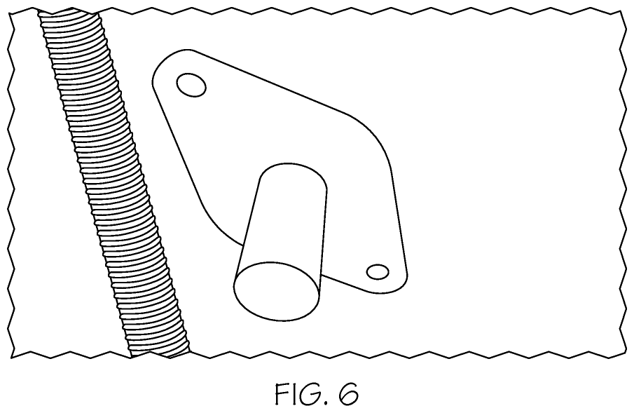

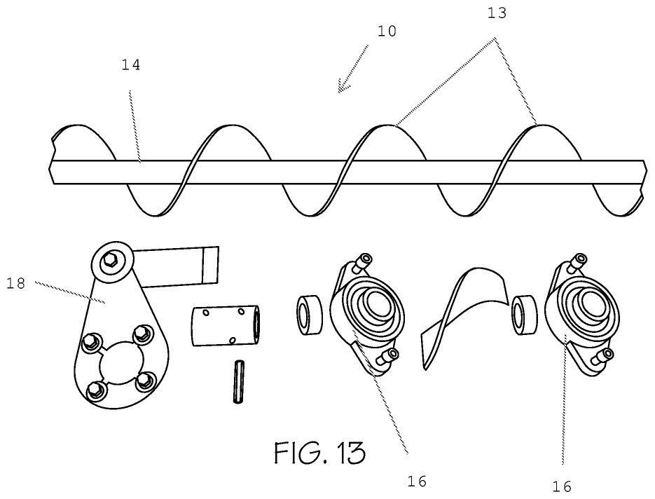

FIG. 6 is a view showing the other end of the auger 10 extending through the wall of the forage bagger machine, as well as the attachment point for the other bearing part (see FIGS. 2 and 13).

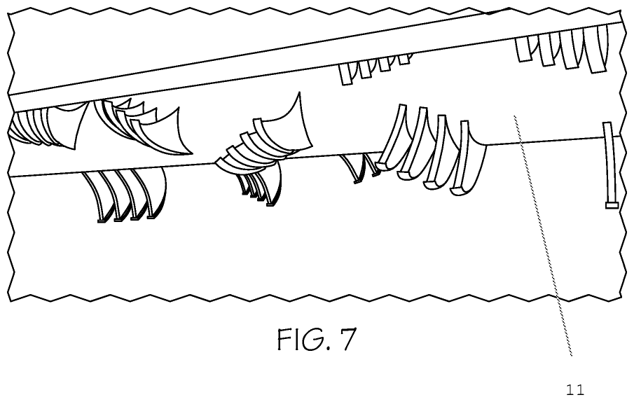

FIG. 7 is a view showing the compaction rotor of a conventional forage bagger machine.

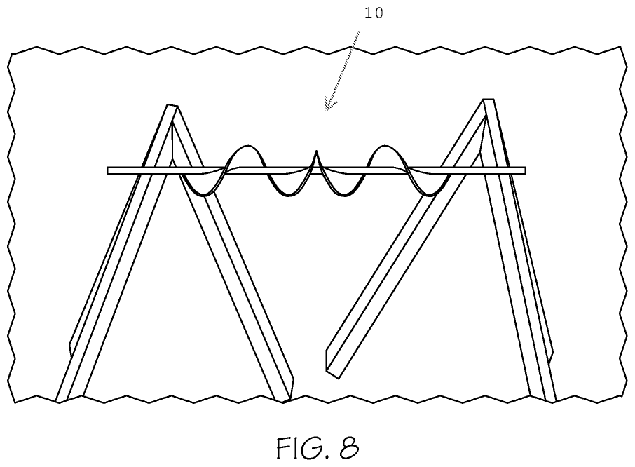

FIG. 8 is a view showing a mini show auger.

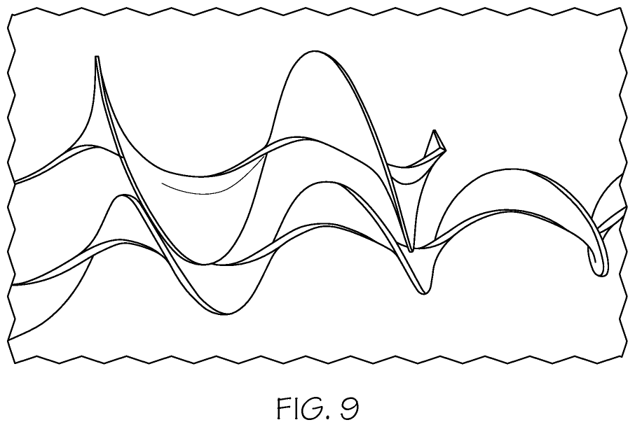

FIG. 9 is a view showing the 8 inch spacing between flights (pitch) next to a version with 5 inch spacing between flights.

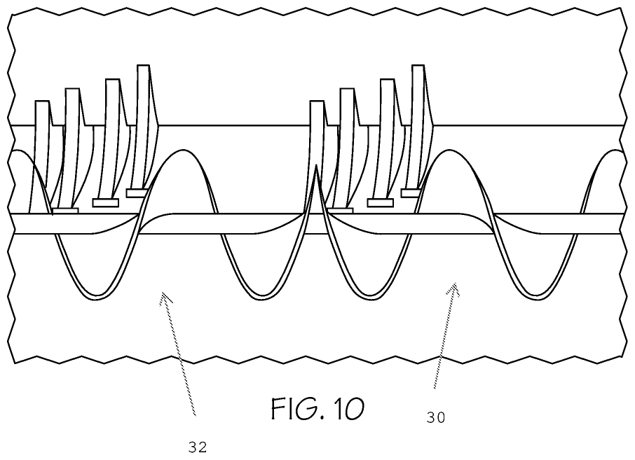

FIG. 10 is a view showing an alternate embodiment of the turbo auger, with a two way feed arrangement. Material is moved to the right at 30 and moved to the left at 32, for situations where material is dumped into the center of the hopper, rather than at one end or the other of the hopper.

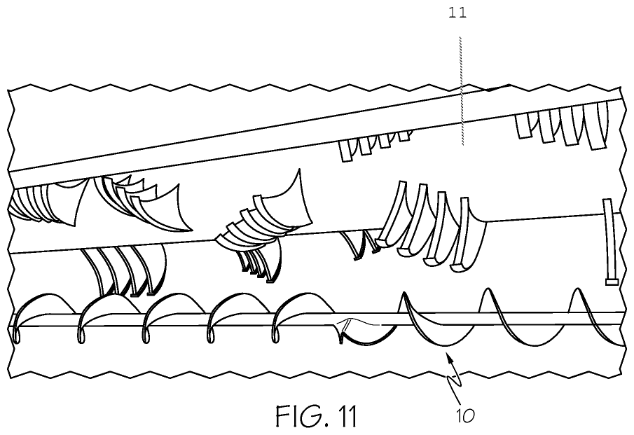

FIG. 11 is another view showing the alternative two direction embodiment installed in a forage bagger machine.

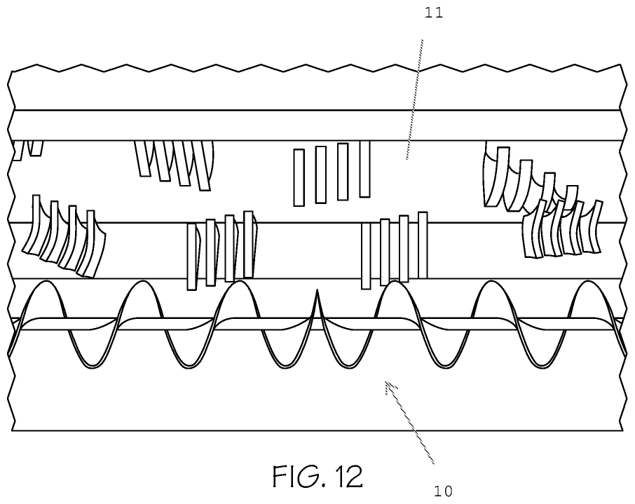

FIG. 12 is another view showing another alterative embodiment installed in a forage bagger machine with 8 inch spacing by 8 inch wide (4 inches from center of shaft).

FIG. 13 is a view showing the parts of the inventive turbo auger.

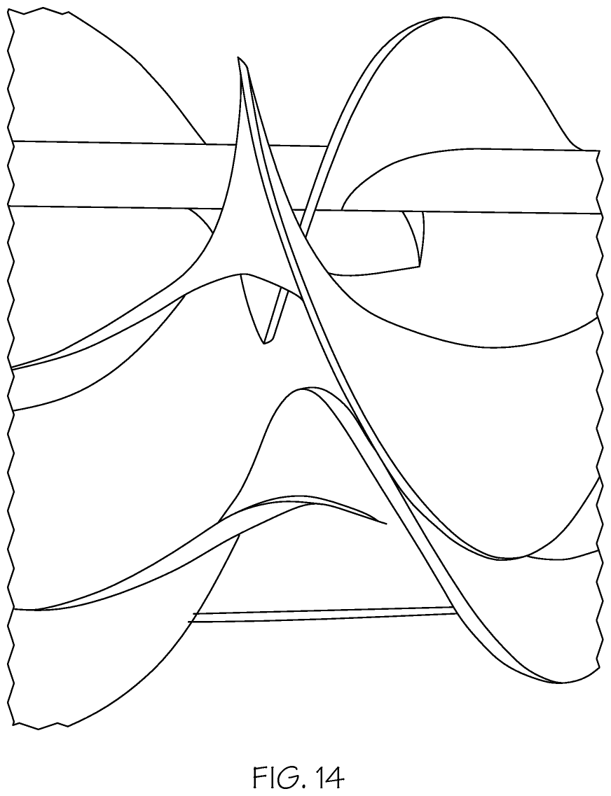

FIG. 14 is an enlarged view showing the 8 inch spacing of the flights of the auger.

What is claimed is:

1. A compacting machine of the type having a compaction rotor, the improvement comprising:
a rotating auger positioned before the compaction rotor, to spread material to be compacted along an entire front of the compaction rotor.

2. The compacting machine of claim 1 wherein the auger is positioned one inch in front of the compaction rotor and one inch off a feeding surface.

3. The compacting machine of claim 1 wherein the auger has a spacing of 8 inches between flights.

4. The compacting machine of claim 1 wherein the auger flights extend 2.5 inches from the center of a shaft of the auger, with the shaft being 1.25 inches in diameter.

5. The compacting machine of claim 4 wherein the auger shaft is made of 4140 steel.

6. The compacting machine of claim 1 wherein the auger is constructed and arranged for one direction feeding.

7. The compacting machine of claim 1 wherein the auger is constructed and arranged for two direction feeding.

8. A forage bagger machine comprising:
a hopper containing a compaction rotor and a feeding mechanism to feed forage to the hopper, the compaction rotor feeding forage into a bag;
a rotating auger positioned a first predetermined distance above a floor of the hopper and a second predetermined distance in front of the compaction rotor, to spread material placed into the hopper along an entire front of the compaction rotor so the material is more evenly compacted into the bag.

9. The compacting machine of claim 8 wherein the first predetermined distance is one inch and the second predetermined distance is one inch.

10. The compacting machine of claim 8 wherein the auger has a spacing of 8 inches between flights.

11. The compacting machine of claim 8 wherein the auger flights extend 2.5 inches from the center of a shaft of the auger, with the shaft being 1.25 inches in diameter.

12. The compacting machine of claim 8 wherein the auger flights extend 4 inches from the center of a shaft of the auger, with the shaft being 1.25 inches in diameter.

13. The compacting machine of claim 11 wherein the auger shaft is made of 4140 steel.

14. The compacting machine of claim 8 wherein the auger is constructed and arranged for one direction feeding.

15. The compacting machine of claim 8 wherein the auger is constructed and arranged for two direction feeding.
